(19) United States
(12) Patent Application Publication
(10) Pub. No.: US 2009/0128545 A1
(43) Pub. Date: May 21, 2009

(54) DISPLAY DEVICE AND CONTROL METHOD THEREOF

(76) Inventors: Seung-Kyu Lee, Suwon-si (KR); Shang-Min Yhee, Seoul (KR); Kook-Chul Moon, Seoul (KR); Teruo Katakura, Suwon-si (KR); Sang-Hoon Lee, Seoul (KR)

Correspondence Address: F. CHAU & ASSOCIATES, LLC, 130 WOODBURY ROAD, WOODBURY, NY, 11797, US

(21) Appl. No.: 12/236,138

(22) Filed: Sep. 23, 2008

(30) Foreign Application Priority Data
Nov. 16, 2007 (KR) 10- 2007-0117336

(51) Int. Cl. G06F 3/038

(52) U.S. Cl. 345/214

(57) ABSTRACT

A display device includes a display panel that has a plurality of gate lines and a plurality of data lines intersecting each other, a plurality of sensing lines that is formed in the display panel, a sensing driver that applies a sensing scan signal to the plurality of sensing lines and receives a predetermined electrical signal from the plurality of sensing lines corresponding to an external stimulus, and a demultiplexer that is provided between the sensing lines and the sensing driver and time-divides each sensing scan signal transmitted by the sensing driver to be sequentially applied to at least two sensing lines.

### CROSS-REFERENCE TO RELATED APPLICATION

This application claims priority from Korean Patent Application No. 10-2007-0117336, filed on Nov. 16, 2007, in the Korean Intellectual Property Office, the disclosure of which is incorporated herein by reference.

### BACKGROUND OF THE INVENTION

1. Technical Field

The present invention relates to a display device and a control method thereof.

2. Discussion of Related Art

Among display devices, a liquid crystal display (LCD) includes two substrates having pixel electrodes and a common electrode, with a liquid crystal layer interposed therebetween and having a dielectric anisotropy. Such an LCD forms an electric field on the liquid crystal layer by applying voltages to the pixel electrodes and the common electrode, and displays a desired image thereon by adjusting an intensity of the electric field and a transmittance of light passing through the liquid crystal layer.

A display device that has a touch screen function includes a touch screen panel so that a user can select from the contents displayed on a screen of a display panel, and can write or draw pictures with his/her hand or with a pen.

The display device having the touch screen panel has been increasingly used, because it does not require an additional input unit, such as a keyboard or a mouse to select a content displayed on the display panel.

The touch screen panel is classified into an external type that is additionally attached to a top of the display panel, and a built-in type that is provided in the display panel and recognizes a position by detecting a change in voltages or resistances.

The built-in touch screen panel includes a plurality of X axis sensing lines formed at predetermined intervals along data lines in pixel regions of the display panel, a plurality of Y axis sensing lines formed at predetermined intervals along gate lines therein, and a sensing driver connected to each of the sensing lines, to thereby detect a position in a matrix array. When a user presses a predetermined point of the screen of the display panel, electrical signals are transmitted to the sensing driver through the specifically pressed X and Y axes sensing lines, among the plurality of X and Y axes sensing lines, to detect the position of the pressed point in the X and Y directions.

Recently, the resolution of the display panel has risen and, accordingly, the resolution of the touch screen also rises. The number of sensing lines should therefore increase to enhance the resolution of the touch screen.

The display device having the touch screen panel employs more driving chips, which form the sensing driver, in accordance with the increased sensing lines to enhance the resolution of the touch screen. Thus, the configuration becomes complicated, and the size of the display panel increases.

### SUMMARY OF THE INVENTION

Additional exemplary embodiments of the present invention will be set forth in part in the description that follows and, in part, will be understood from the description, or may be learned by practice of the present invention.

The foregoing and/or other exemplary embodiments of the present invention are achieved by providing a display device, including a display panel that has a plurality of gate lines and a plurality of data lines intersecting each other and defining a plurality of pixels, a plurality of sensing lines that is formed in the display panel, a sensing driver that applies a sensing scan signal to the plurality of sensing lines and receives a predetermined electrical signal from the plurality of sensing lines corresponding to an external stimulus; and a demultiplexer that is provided between the sensing lines and the sensing driver and that time-divides each sensing scan signal transmitted by the sensing driver to be sequentially applied to at least two sensing lines.

The demultiplexer may include a plurality of switching elements that is formed on the display panel and sequentially applies each sensing scan signal transmitted by the sensing driver to at least two sensing lines.

The switching elements may include poly silicon.

The demultiplexer may sequentially apply each sensing scan signal transmitted by the sensing driver to the at least two sensing lines.

The display device may further include a data driver to apply data voltages to the data lines, wherein the sensing driver and the data driver are formed in a single driving chip.

The sensing lines may comprise a plurality of first sensing lines extending in parallel with the data lines and a plurality of second sensing lines intersecting the first sensing lines, the demultiplexer may include a first demultiplexer connected to the plurality of first sensing lines and a second demultiplexer connected to the plurality of second sensing lines, and the sensing driver may include a first sensing driver connected to the first demultiplexer and a second sensing driver connected to the second demultiplexer.

The display device may further include a plurality of sensing signal lines that is formed between the sensing drivers and the demultiplexers, wherein the sensing drivers sequentially apply the sensing scan signal to the plurality of sensing signal lines.

The sensing drivers may compare an electrical signal received from the sensing lines with a preset reference value, and output an analog signal corresponding to the electrical signal when the electrical signal exceeds the reference value.

The display device may further include a signal controller that outputs the sensing scan signal to the sensing drivers, convert the analog signal into a digital signal, and determine position information corresponding to an external stimulus based on a predetermined clock signal and the digital signal.

The foregoing and/or other exemplary embodiments of the present invention are also provided by a control method of a display device that has a display panel having a plurality of sensing lines and a sensing driver driving the plurality of sensing lines, the control method including applying a sensing scan signal from the sensing driver to the plurality of sensing lines, time-dividing and demultiplexing each sensing scan signal transmitted by the sensing driver to be sequentially applied to at least two sensing lines, and receiving a predetermined electrical signal corresponding to an external stimulus when the sensing scan signal is applied to the sensing lines and the external stimulus is generated in the sensing lines.

The time-dividing and demultiplexing of the sensing scan signal may include sequentially applying the sensing scan signal transmitted by the sensing driver to at least two sensing lines by using a plurality of switching elements.

The control method may further include forming a plurality of sensing signal lines between the sensing driver and a demultiplexer, wherein the sensing driver sequentially applies the sensing scan signal to the plurality of sensing signal lines.

Four or six switching elements may be connected to each of the sensing signal lines to sequentially apply each sensing scan signal transmitted by the sensing driver to the at least two sensing lines.

The control method may further include comparing an electrical signal received from the sensing lines with a preset reference value by the sensing driver, and outputting an analog signal corresponding to the electrical signal when the electrical signal exceeds the reference value.

The control method may further include converting an outputted analog signal into a digital signal and determining position information corresponding to an external stimulus based on a predetermined clock signal and the digital signal.

### BRIEF DESCRIPTION OF THE DRAWINGS

Exemplary embodiments of the present invention will be understood in more detail from the following descriptions taken in conjunction with the accompanying drawings, of which:

FIG. 1 is a block diagram of a display device according to an exemplary embodiment of the present invention;

FIG. 2 is a schematic block diagram of a demultiplexer of a display device according to an exemplary embodiment of the present invention;

FIG. 3 is a waveform diagram of signals useful in describing operation of the demultiplexer shown in FIG. 2;

FIG. 4 is a waveform diagram of signals useful in describing operation of a sensing driver of the display device according to an exemplary embodiment of the present invention;

FIG. 5 is a block diagram of the display device shown in FIG. 1 when employing a single driving chip; and

FIG. 6 is a control flowchart of a display device according to an exemplary embodiment of the present invention.

### DETAILED DESCRIPTION OF EXEMPLARY EMBODIMENTS

Hereinafter, exemplary embodiments of the present invention will be described with reference to the accompanying drawings, wherein like numerals refer to like elements and repetitive descriptions will be avoided as necessary.

Hereinafter, a liquid crystal display will be described as an example of a display device, however, the present invention is not limited to the liquid crystal display, and may be applicable to other types of display devices, such as an organic light emitting device (OLED) and an electrophoretic display device.

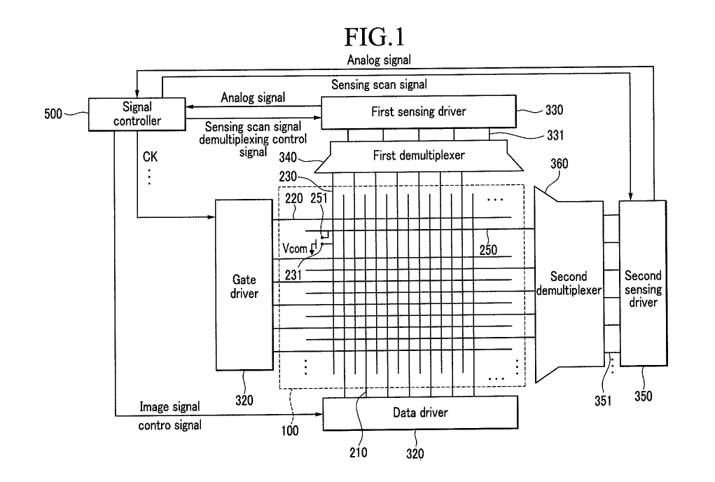

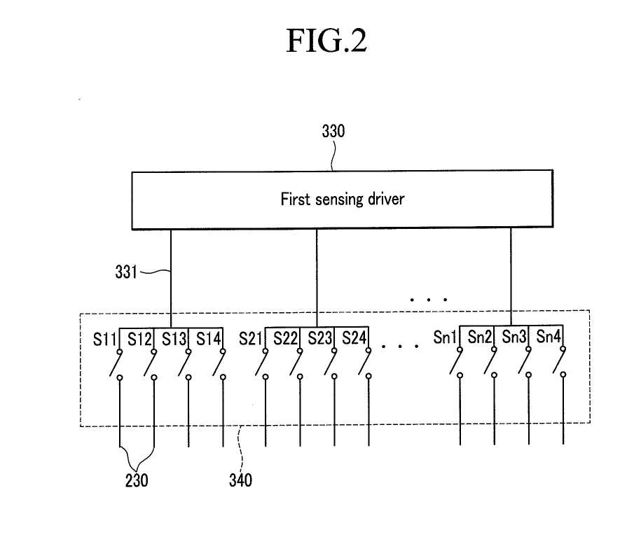

FIG. 1 is a block diagram of a display device according to an exemplary embodiment of the present invention, and FIG. 2 is a schematic block diagram of a demultiplexer used in the display device of FIG. 1 according to an exemplary embodiment of the present invention.

The display device according to an exemplary embodiment of the present invention includes a display device that has a touch screen function to perform an operation selected by an externally applied pressure. The display device is a built-in type that includes sensing electrodes 231 and 251 and respective sensing lines 230 and 250 in a display panel 100.

The display device includes the display panel 100 having a display region therein, panel drivers 310 and 320 and first and second sensing drivers 330 and 350 connected to the display panel 100, first and second demultiplexers (DEMUXs) 340 and 360 provided between the first and second sensing drivers 330 and 350 and the sensing lines 230 and 250, respectively, and a signal controller 500 generating various signals to be applied to the panel drivers 310 and 320 and to the first and second sensing drivers 330 and 350.

The display panel 100 includes a liquid crystal panel having a liquid crystal layer as an exemplary embodiment of the present invention, but is not limited thereto. Alternatively, the display panel 100 may include organic light emitting diodes having an organic light emitting layer.

The display panel 100 includes a plurality of pixels formed in a matrix pattern. A plurality of data lines 210, a plurality of gate lines 220, and a plurality of thin film transistors (not shown) are formed in the display panel 100. The data lines 210 extend in one direction (a vertical direction in FIG. 1), the gate lines 220 insulatedly intersect the data lines 210 and define pixels and the thin film transistors are formed in intersection areas between the data lines 210 and the gate lines 220.

The sensing electrodes 231 and 251 and a plurality of sensing lines 230 and 250 are formed in the display panel 100. The sensing electrodes 231 and 251 generate predetermined electrical signals in reaction to an external stimulus. The plurality of sensing lines 230 and 250 are respectively connected to the sensing electrodes 231 and 251. When an external stimulus is provided, a common electrode Vcom applied to an overall surface of the display panel 100 is supplied to the sensing electrodes 231 and 251. The transmitted electrical signals are outputted to the sensing drivers 330 and 350 through the sensing electrodes 231 and 251 and the sensing lines 230 and 250, respectively.

The sensing electrodes 231 and 251 are formed uniformly across the display panel 100. The sensing electrodes 231 and 251 include first sensing electrodes 231 that inform position information of the stimulus-generated point in a horizontal direction (based on FIG. 1), and a second sensing electrodes 251 that inform position information of the stimulus-generated point in a vertical direction (based on FIG. 1). The first sensing electrodes 231 are connected to the respective first sensing lines 230, while the second sensing electrodes 251 are connected to the respective second sensing line 250.

The first sensing lines 230 are arranged in parallel with the data lines 210. At least one data line 210 is formed between every pair of neighboring first sensing lines 230. The single data line 210 is formed between the pair of neighboring first sensing lines 230 as an exemplary embodiment of the present invention, but is not limited thereto. Alternatively, two or more data lines 210 may be formed between the pair of neighboring first sensing lines 230.

The second sensing lines 250 are arranged in parallel with the gate lines 220. At least one gate line 220 is formed between every pair of neighboring second sensing lines 250. The single gate line 220 is formed between the pair of neighboring second sensing lines 250 as an exemplary embodiment of the present invention, but is not limited thereto. Alternatively, two or more gate lines 220 may be formed between the pair of neighboring second sensing lines 250.

The panel drivers 310 and 320 of the display panel 100 include a data driver 310 connected to the data lines 210 and a gate driver 320 connected to the gate lines 220. The panel drivers 310 and 320 are connected to the signal controller 500. At least one of the panel drivers 310 and 320 may be provided as a driving chip and mounted on the display panel 100.

The data driver 310 applies data voltages to the data lines 210, while the gate driver 320 applies gate signals including a gate-on voltage and a gate-off voltage to the gate lines 220.

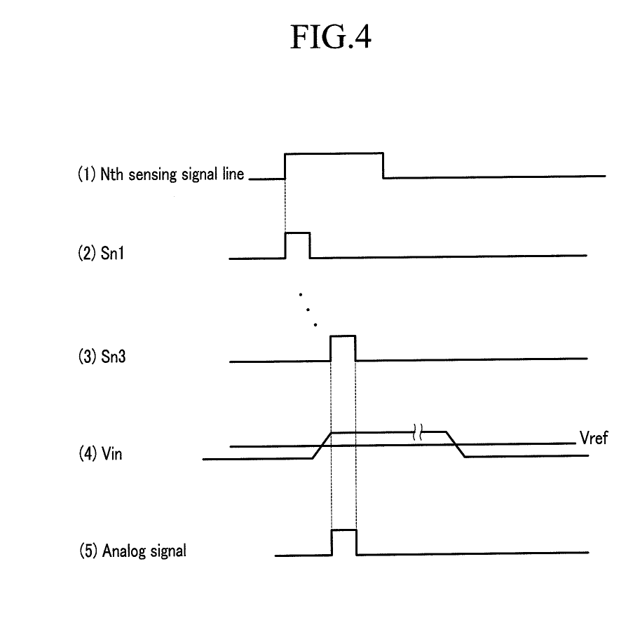

The sensing drivers 330 and 350 apply sensing scan signals to the plurality of sensing lines 230 and 250, respectively, and receive predetermined electrical signals corresponding to an external stimulus from the plurality of sensing lines 230 and 250. The sensing drivers 330 and 350 sequentially output sensing scan signals and demultiplexing control signals from the signal controller 500 to the demultiplexers 340 and 360, respectively, and scan the plurality of sensing lines 230 and 250. The sensing drivers 330 and 350 compare the electrical signals respectively received from the sensing lines 230 and 250 with a preset reference value, and output analog signals corresponding to the electrical signals when the electrical signals exceed the reference value. Each of the electrical signal includes a measurable voltage. Thus, the sensing drivers 330 and 350 compare voltages (hereinafter, referred to as “input voltages”) Vin inputted thereto, shown in FIG. 4, transmitted by the first sensing electrode 231 and the second sensing electrode 250 with a predetermined reference value Vref, shown in FIG. 4, respectively, and output analog signals to the signal controller 500 corresponding to the input voltages Vin when the input voltages Vin exceeds the reference value Vref, respectively.

For example, when an external stimulus is applied to a region corresponding to the first sensing electrode 231, the common voltage Vcom is inputted to the first sensing driver 330 through a corresponding first sensing electrode 231, the first sensing line 230 connected to the corresponding first sensing electrode 231, and the first demultiplexer 340. The first sensing driver 330 compares the input voltage Vin with the predetermined reference value Vref and outputs a particular analog signal only when the input voltage Vin exceeds the reference voltage Vref. That is, the sensing drivers 330 and 350 sample only voltages that are determined to be caused by the stimulus among the inputted voltages, then change the voltages into the analog signals, and output the analog signals, respectively. The sensing drivers 330 and 350 may include switches (not shown) to receive the sensing scan signals from the signal controller 500 and sequentially apply the sensing scan signals to the demultiplexers 340 and 360 through the sensing signal lines 331 and 351, respectively.

The sensing drivers 330 and 350 include a first sensing driver 330 to drive the first sensing lines 230 and a second sensing driver 350 to drive the second sensing lines 250.

The first sensing driver 330 is connected to the first demultiplexer 340 through the plurality of first sensing signal lines 331, and the second sensing driver 350 is connected to the second demultiplexer 360 through the plurality of second sensing signal lines 351. The first and second sensing drivers 330 and 350 are similar as an exemplary embodiment of the present invention.

FIG. 2 illustrates an exemplary embodiment of the first sensing driver 330 and the first demultiplexer 340. The demultiplexers 340 and 360 will be described in detail with reference to FIG. 2.

The first demultiplexer 340 time-divides each sensing scan signal transmitted by the first sensing driver 330 and sequentially applies the sensing scan signal to at least two first sensing lines 230. The first demultiplexer 340 includes a plurality of switching elements S11, S12 . . . Sn1 . . . to sequentially apply each sensing scan signal to the at least two first sensing lines 230 according to a demultiplexing control signal transmitted by the first sensing driver 330. Alternatively, the first demultiplexer 340 may be directly connected to the signal controller 500 to receive the demultiplexing control signal.

In FIG. 2, the first demultiplexer 340 sequentially applies each sensing scan signal from the first sensing driver 330 to four first sensing lines 230 as an exemplary embodiment of the present invention. That is, as each of the sensing signal lines 331 is connected to four switching elements S11, S12, S13 and S14, the first demultiplexer 340 sequentially applies each sensing scan signal from the first sensing driver 330 to the four first sensing lines 230. Alternatively, the first demultiplexer 340 may sequentially apply each sensing scan signal to two, three, five, or six or more of first sensing lines 230.

The second demultiplexer 360 is the same as the first demultiplexer 340 as an exemplary embodiment of the present invention, but is not limited thereto. Alternatively, the second sensing signal lines 351 may be connected with a different number of the second sensing lines 250 from that of the first sensing lines 230 connected to the first sensing signal lines 331.

Each of the switching elements S11, S12 . . . Sn1 . . . includes a thin film transistor employing a semiconductor layer having poly silicon, as an exemplary embodiment of the present invention, but is not limited thereto. Alternatively, each switching element S11, S12 . . . Sn1 . . . may include an amorphous silicon semiconductor layer. The poly silicon semiconductor layer moves an electric charge faster than the amorphous silicon semiconductor layer does. The method of forming the switching elements S11, S12 . . . Sn1 . . . including poly silicon semiconductor layers is known in the art, and detailed descriptions will be avoided. The switching elements S11, S12 . . . Sn1 . . . may be connected to the signal controller 500 and controlled by a demultiplexing control signal of the signal controller 500.

The signal controller 500 outputs image signals to be applied to the display panel 100, as well as overall control signals. The signal controller 500 is connected to the sensing drivers 330 and 350 and outputs sensing scan signals to the sensing drivers 330 and 350, receives analog signals from the sensing drivers 330 and 350, and determines position information about an external stimulus-generated region.

The signal controller 500 receives image signals (not shown) from the outside, processes the received image signals and outputs the image signals to the data driver 310. The signal controller 500 outputs various control signals such as a clock signal CK to other elements including the gate driver 320.

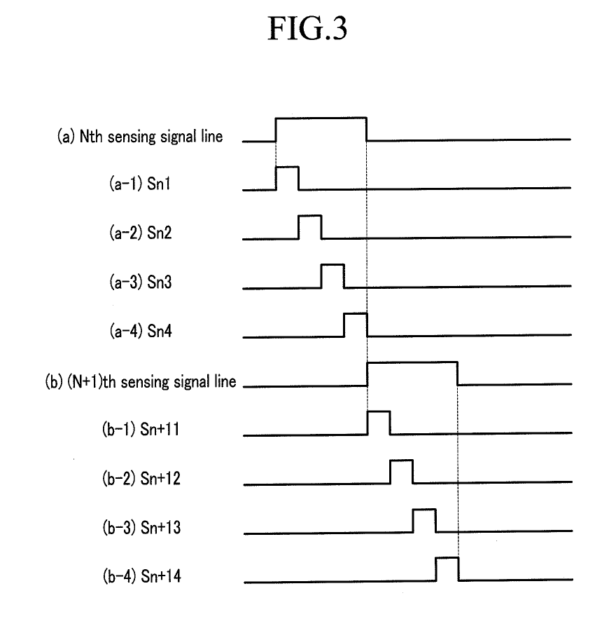

FIG. 3 illustrates operations of the demultiplexers 340 and 360 according to an exemplary embodiment of the present invention. The first demultiplexer 340 shown in FIG. 2 will be described with reference to FIG. 3.

As shown therein, (a) refers to an Nth first sensing signal line 331 that is turned on to receive a sensing scan signal from the first sensing driver 330. (a-1), (a-2), (a-3) and (a-4) refer to switching elements Sn1, Sn2, Sn3 and Sn4, respectively, connected to the Nth first sensing line 331 and sequentially turned on and off, while the Nth first sensing signal line 331 is turned on. The sensing scan signal may be sequentially applied to the first sensing line 230 connected to the switching elements Sn1, Sn2, Sn3, and Sn4, shown in FIG. 2.

In FIG. 3, (b) refers to an (N+1)th sensing signal line 331 that is turned on to receive a sensing scan signal from the first sensing driver 330, while the nth first sensing signal line 331 is turned off.

In FIG. 3 (b-1), (b-2), (b-3) and (b-4) refer to switching elements Sn+11, Sn+12, Sn+13, and Sn+14, respectively, connected to the (N+1)th first sensing signal line 331 and sequentially turned on and off, while the (N+1)th first sensing signal line 331 is turned on.

The first demultiplexer 340 may sequentially apply a sensing scan signal to the plurality of first sensing lines 230. When an external stimulus is generated, a predetermined electrical signal is transmitted to the first sensing driver 330, while the first sensing lines 230 receive the sensing scan signal.

The second demultiplexer 360 is similar to the first demultiplexer 340 as an exemplary embodiment of the present invention. Thus, detailed descriptions will be omitted.

The display device according to exemplary embodiments of the present invention may have more sensing lines 230 and 250 on the display panel 100 than the conventional display device does to enhance resolution of the touch screen. As the number of sensing signal lines 331 and 351 respectively connected to the sensing drivers 330 and 350 is smaller than that of the sensing lines 230 and 250 by four times, the number of driving chips including the sensing drivers 330 and 350 does not increase. Thus, the display device according to exemplary embodiments of the present invention prevents the number of driving chips from increasing, even when the resolution of the touch screen is enhanced. Thus, the configuration of the display device is simple and the size of the panel does not increase.

The signal controller 500 outputs sensing scan signals and synchronization signals to the sensing drivers 330 and 350, respectively. The sensing scan signal sequentially scans the sensing lines 230 or 250 and detects whether an analog signal is inputted. The sensing scan signal is outputted from the signal controller 500 and transmitted to the neighboring sensing driver 330 or 350 in a particular direction. The sensing drivers 330 and 350 sequentially apply the sensing scan signals to each of the sensing signal lines 331 and 351, respectively. When the sensing scan signal is applied to the sensing signal lines 331 or 351, the switching elements S11, S12 . . . Sn1 . . . of the demultiplexer 340 or 360 connected to the sensing signal lines 331 or 351 are sequentially turned on. When the switching elements S11, S12 . . . Sn1 . . . are turned on, the sensing driver 330 or 350 output an analog signal to the signal controller 500.

FIG. 4 illustrates operation of the sensing driver 330 according to an exemplary embodiment of the present invention. The first sensing driver 330 will be described with reference to FIG. 4. As the second sensing driver 350 is similar to the first sensing driver 330, detailed descriptions thereof will be omitted.

(1) refers to the Nth first sensing signal line 331 that is turned on by the first sensing driver 330.

(2) and (3) refer to switching elements Sn1, Sn2, Sn3 and Sn4 of the first demultiplexer 340 that are sequentially turned on, while the Nth first sensing signal line 331 is turned on.

(4) refers to an input voltage Vin inputted from the first sensing line 230 that exceeds the reference voltage Vref receiving the external stimulus when the switching element Sn3 of the first demultiplexer 340 is turned on and when the first sensing line 230 connected to the switching element Sn3 receives the external stimulus, that is, an applied force.

(5) refers to an analog signal that is outputted from the first sensing driver 330 receiving the input voltage Vin to the signal controller 500 when the switching element Sn3 is turned on.

The sensing scan signals are outputted from the signal controller 500 to the sensing drivers 330 and 350 corresponding to a frame displaying an image. That is, a sensing scan signal may be outputted for each frame or outputted for two or more frames. The sensing scan signal corresponds to a clock signal.

The signal controller 500 converts analog signals inputted by the sensing drivers 330 and 350 into predetermined digital signals, and determines position information corresponding to the external stimulus based on the predetermined clock signal and the digital signals. The signal controller 500 counts a clock signal at the timing of generating the digital signals to determine the position on the display panel 100 where the external stimulus is applied. That is, a sensing scan signal is outputted to each of the sensing signal lines 331 or 351 corresponding to four clock signals. A sensing scan signal applied to the switching elements S11, S12 . . . Sn1 . . . of the demultiplexer 340 or 360 corresponds to a single clock signal. The signal controller 500 may determine whether the switching elements S11, S12 . . . Sn1 . . . connected to the sensing lines 230 or 250 are turned on and determine which sensing lines 230 or 250 correspond to the external stimulus by counting the clock signal.

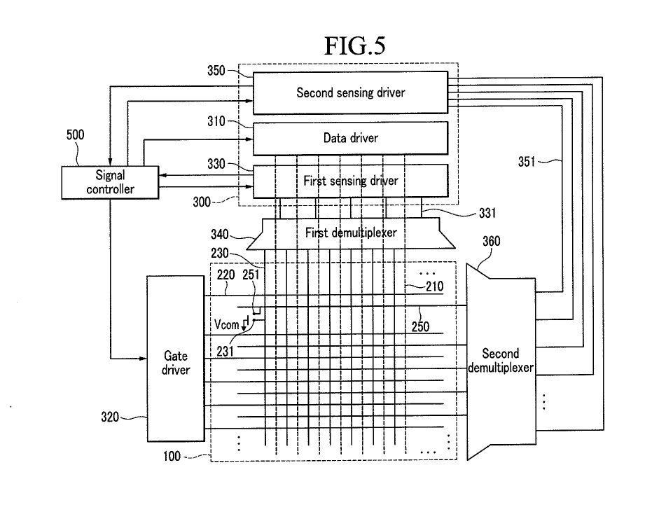

FIG. 5 illustrates an exemplary embodiment of a display device such as shown in FIG. 1, except only a single driving chip is used.

A single driving chip 300 may be mounted in an insulating substrate of the display panel 100 by the known chip on glass (COG) method or mounted in a flexible film (not shown) to be connected to the display panel 100 by the known chip on film (COF) method. When the driving chip 300 is mounted in the flexible film, signal leads (not shown) are formed on the flexible film to be connected to the signal controller 500 using various signal lines 210, 220, 230 and 250. The single driving chip 300 is provided as an exemplary embodiment of the present invention. The single driving chip 300 may include the data driver 310 and the first and second sensing drivers 330 and 350, respectively. That is, when the display panel 100 of the display device according to the exemplary embodiment of the present invention is about 3.5 or about 4.3 inches square and the resolution of the display panel 100 is about 480 (the number of pixels in the transverse direction)×about 272 (the number of pixels in the vertical direction), the single driving chip 300 may include the data driver 310 and the sensing drivers 330 and 350. According to an exemplary embodiment of the present invention, the gate driver 320 may be directly formed in the display panel 100 instead of being mounted in the driving chip 300. For example, the gate driver 320 may be formed on the insulating substrate of the display panel 100 in the same process as forming the thin film transistors. Alternatively, the gate driver 320 may be included in the driving chip 300.

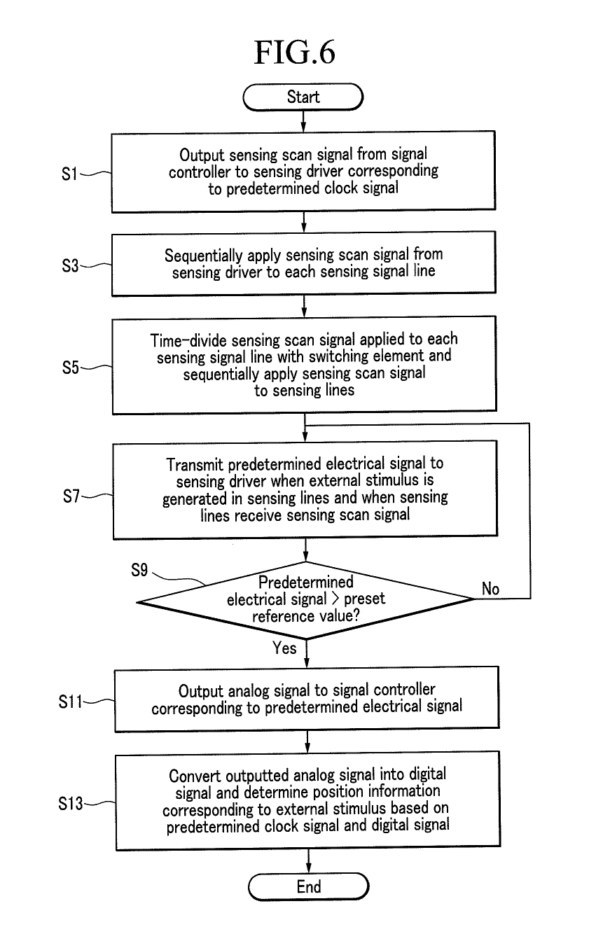

FIG. 6 is a control flowchart of the display device according to an exemplary embodiment of the present invention, and a control method of the display device according to an exemplary embodiment of the present invention will be described with reference to FIG. 6 and to FIG. 1.

The signal controller 500 outputs the sensing scan signals to the sensing drivers 330 and 350 corresponding to the predetermined clock signal, respectively in step S1. The sensing drivers 330 and 350 then sequentially apply the sensing scan signals to each of the sensing signal lines 331 and 351, respectively in step S3.

Each of the demultiplexers 340 and 360 time-divides the sensing scan signal applied to the sensing signal lines 331 and 351 with the switching elements S11, S12 . . . Sn1 . . . and sequentially apply the sensing scan signal to the sensing lines 230 and 250 in step S5. The plurality of sensing lines 230 and 250 receives the sensing scan signal sequentially. When the external stimulus is generated in the sensing lines 230 and 250, the electrical signals are generated by the external stimulus and outputted to the sensing drivers 330 and 350 while the switching elements S11, S12 . . . Sn1 . . . are turned on to apply the sensing scan signals to the sensing lines 230 and 250 in step S7.

Each of the sensing drivers 330 and 350 compares the applied electrical signal with the preset reference value in step S9. When the applied electrical signal exceeds the reference value, each sensing driver 330 and 350 outputs the analog signal corresponding to the applied electrical signal to the signal controller 500 in step S11. When the applied electrical signal does not exceed the reference value, the sensing driver 330 or 350 does not output the analog signal to the signal controller 500.

The signal controller 500 converts the received analog signals into digital signals, and determines the position information corresponding to the external stimulus based on the predetermined clock signal and the digital signals in step S13.

With the foregoing configuration, the display device according to an exemplary embodiment of the present invention has a smaller number of signal lines connected to a sensing driver than previously provided and prevents the number of driving chips, including the sensing driver, from increasing and enhances the resolution of the touch screen by sequentially applying a sensing scan signal. The display device according to an exemplary embodiment of the present invention prevents the number of driving chips and the size of the display panel from increasing and has a simple configuration, while enhancing the resolution of the touch screen.

As described above, an exemplary embodiment of the present invention provides a display device that has a simple configuration and that prevents a size of the display panel from increasing, while enhancing the resolution of the touch screen.

Although exemplary embodiments of the present invention have been shown and described, it will be appreciated by those of ordinary skill in the art that changes may be made in these exemplary embodiments without departing from the principles and spirit of the present invention, the scope of which is defined in the appended claims and their equivalents.

What is claimed is:

1. A display device, comprising:
a display panel that has a plurality of gate lines and a plurality of data lines intersecting each other;
a plurality of sensing lines formed in the display panel;
a sensing driver that applies a sensing scan signal to the plurality of sensing lines and receives a predetermined electrical signal from the plurality of sensing lines corresponding to an external stimulus applied to the display panel; and
a demultiplexer that is provided between the sensing lines and the sensing driver and time-divides each sensing scan signal transmitted by the sensing driver to be sequentially applied to at least two sensing lines.

2. The display device of claim 1, wherein the demultiplexer comprises a plurality of switching elements formed on the display panel and sequentially applies each sensing scan signal transmitted by the sensing driver to at least two sensing lines.

3. The display device of claim 2, wherein the switching elements comprise poly silicon.

4. The display device of claim 1, wherein the demultiplexer sequentially applies each sensing scan signal transmitted by the sensing driver to the at least two sensing lines.

5. The display device of claim 1, further comprising a data driver applying data voltages to the data lines, wherein
the sensing driver and the data driver are formed in a single driving chip.

6. The display device of claim 1, wherein the plurality of sensing lines comprise a plurality of first sensing lines extending in parallel with the data lines and a plurality of second sensing lines intersecting the first sensing lines,
the demultiplexer comprises a first demultiplexer connected to the plurality of first sensing lines and a second demultiplexer connected to the plurality of second sensing lines, and
the sensing driver comprises a first sensing driver connected to the first demultiplexer and a second sensing driver connected to the second demultiplexer.

7. The display device of claim 1, further comprising a plurality of sensing signal lines formed between the sensing driver and the demultiplexer, wherein
the sensing driver sequentially applies the sensing scan signal to the plurality of sensing signal lines.

8. The display device of claim 1, wherein the sensing driver compares an electrical signal received from the sensing lines with a preset reference value, and outputs an analog signal corresponding to the electrical signal when the electrical signal exceeds the reference value.

9. The display device of claim 8, further comprising a signal controller that outputs the sensing scan signal to the sensing driver, converts the analog signal into a digital signal and determines position information corresponding to the external stimulus based on a predetermined clock signal and the digital signal.

10. A control method of a display device that has a display panel having a plurality of sensing lines and a sensing driver driving the plurality of sensing lines, the control method comprising:
applying a sensing scan signal from the sensing driver to the plurality of sensing lines;
time-dividing and demultiplexing each sensing scan signal transmitted by the sensing driver to be sequentially applied to at least two sensing lines; and
receiving a predetermined electrical signal corresponding to an external stimulus applied to the display panel when the sensing scan signal is applied to the sensing lines and the external stimulus is generated in the sensing lines.

11. The control method of claim 10, wherein the time-dividing and demultiplexing the sensing scan signal comprises sequentially applying the sensing scan signal transmitted by the sensing driver to at least two sensing lines using a plurality of switching elements.

12. The control method of claim 11, further comprising forming a plurality of sensing signal lines between the sensing driver and a demultiplexer, wherein
the sensing driver sequentially applies the sensing scan signal to the plurality of sensing signal lines.

13. The control method of claim 12, wherein four or six switching elements are connected to each of the sensing signal lines to sequentially apply each sensing scan signal transmitted by the sensing driver to the at least two sensing lines.

14. The control method of claim 10, further comprising comparing an electrical signal received from the sensing lines with a preset reference value using the sensing driver, and
outputting an analog signal corresponding to the electrical signal when the electrical signal exceeds the reference value.

15. The control method of claim 14, further comprising converting an outputted analog signal into a digital signal and determining position information corresponding to the applied external stimulus based on a predetermined clock signal and the digital signal.
